(19) United States
(12) Patent Application Publication
(10) Pub. No.: US 2023/0344492 A1
(43) Pub. Date: Oct. 26, 2023

(54) FAST MEASUREMENT WITH MULTIPLE CONCURRENT BEAMS

(71) Applicant: Apple Inc., Cupertino, CA (US)

(72) Inventors: Qiming Li, Beijing (CN); Dawei Zhang, Saratoga, CA (US); Huaning Niu, San Jose, CA (US); Jie Cui, San Jose, CA (US); Manasa Raghavan, Sunnyvale, CA (US); Xiang Chen, Campbell, CA (US); Yang Tang, San Jose, CA (US); Yushu Zhang, Beijing (CN)

(73) Assignee: Apple Inc., Cupertino, CA (US)

(21) Appl. No.: 17/598,237

(22) PCT Filed: May 10, 2021
(86) PCT No.: PCT/CN2021/092916

§ 371 Date: Sep. 24, 2021

(51) Int. Cl. H04B 7/06; H04W 24/10; H04W 8/24

(52) U.S. Cl. CPC H04B 7/0628; H04W 24/10; H04W 8/24

(57) ABSTRACT

Provided is a method for a user equipment (UE), comprising: generating a message that includes an indication of a capability of the UE indicating whether the UE supports simultaneous measurement for at least two downlink (DL) beams; and transmitting the message to a base station.

### TECHNICAL FIELD

This application relates generally to wireless communication systems, and more specifically to beam measurement.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, a method for a user equipment (UE) is provided that comprises generating a message that includes an indication of a capability of the UE indicating whether the UE supports simultaneous measurement for at least two downlink (DL) beams; and transmitting the message to a base station.

According to an aspect of the present disclosure, a method for a base station (BS) is provided that comprises receiving a message that includes an indication of a capability of a UE indicating whether the UE supports simultaneous measurement for at least two downlink (DL) beams from the UE.

According to an aspect of the present disclosure, a method for a base station (BS) is provided that comprises generating a control signal that indicates whether data transmission or downlink (DL) beam measurement is prioritized for a user equipment (UE); and transmitting the control signal to the UE.

According to an aspect of the present disclosure, a method for a user equipment (UE) is provided that comprises receiving a control signal from a base station (BS), wherein the control signal indicates whether data transmission or downlink (DL) beam measurement is prioritized for the UE.

According to an aspect of the present disclosure, an apparatus for a user equipment (UE) is provided that comprises one or more processors configured to perform steps of the method for the user equipment (UE).

According to an aspect of the present disclosure, an apparatus for a base station (BS) is provided that comprises one or more processors configured to perform steps of the method for the base station (BS).

According to an aspect of the present disclosure, it is provided a computer readable medium having computer programs stored thereon which, when executed by one or more processors, cause an apparatus to perform steps of the above-mentioned method.

According to an aspect of the present disclosure, it is provided a computer program product comprising computer programs which, when executed by one or more processors, cause an apparatus to perform steps of the above-mentioned method.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 illustrates a wireless network 100, in accordance with some embodiments.

FIG. 2 illustrates a flowchart of an example process for indicating a UE capability on a UE side, in accordance with some embodiments.

FIG. 3 illustrates a flowchart of an example process for indicating a UE capability on a base station side, in accordance with some embodiments.

FIG. 4 illustrates a communication exchange between the UE and the base station, in accordance with some embodiments.

FIG. 5 illustrates a flowchart of an example process for controlling measurement of a UE on a base station side, in accordance with some embodiments.

FIG. 6 illustrates an example scene where data transmission is prioritized for the UE.

FIG. 7 illustrates an example scene where DL beam measurement is prioritized for the UE.

FIG. 8 illustrates a flowchart of an example process for controlling measurement of a UE on a UE side, in accordance with some embodiments.

FIG. 9 illustrates an exemplary block diagram of an apparatus for a user equipment in accordance with some embodiments.

FIG. 10 illustrates an exemplary block diagram of an apparatus for a user equipment in accordance with some embodiments.

FIG. 11 illustrates an exemplary block diagram of an apparatus for a base station in accordance with some embodiments.

FIG. 12 illustrates an exemplary block diagram of an apparatus for a user equipment in accordance with some embodiments.

FIG. 13 illustrates example components of a device in accordance with some embodiments.

FIG. 14 illustrates example interfaces of baseband circuitry in accordance with some embodiments.

FIG. 15 illustrates components in accordance with some embodiments.

FIG. 16 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In release 15/16 FR2 (frequency range 2), beam measurement (such as Radio Resource Management measurement) requirements are derived based on an assumption that a UE can measure with only one beam at a time. Typically, the UE needs N (up to 8) beams to meet the spherical coverage requirements since wireless signals have greater attenuation in mmWave, such that the measurement delay is N times in FR2 that as defined in FR1. The latency of the measurement will affect performance of the UE. For example, cell search and measurement in FR2 are much longer compared with that in FR1.

In R17, UE can support simultaneous DL reception from multiple transmission and reception points (TRP) on same carrier. In this way, UE needs to support multiple, i.e., at least two concurrent DL bears. Each beam will be pointed toward corresponding TRP.

The present disclosure provides a fast measurement method for UE supporting multiple concurrent DL beams. When the UE is not in multiple TRP scenario, or if there is still spare beam available for beam measurement, UE can use the supported multiple concurrent beams for measurement.

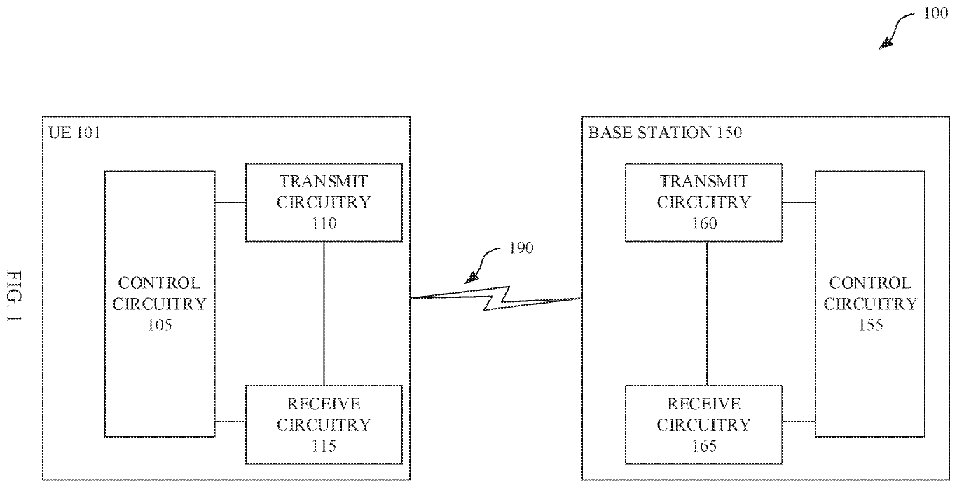

FIG. 1 illustrates a wireless network 100, in accordance with some embodiments. The wireless network 100 includes a UE 101 and a base station 150 connected via an air interface 190. The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120 degree area with an array of antennas directed to each sector to provide 360 degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

The UE and various base stations (for example, base stations that support all kinds of serving cells including PCell and SCell, or base stations that act as the network device of PCell or SCell for communicating with the UE) described in the following embodiments may be implemented by the UE 101 and the base station 150 described in FIG. 1.

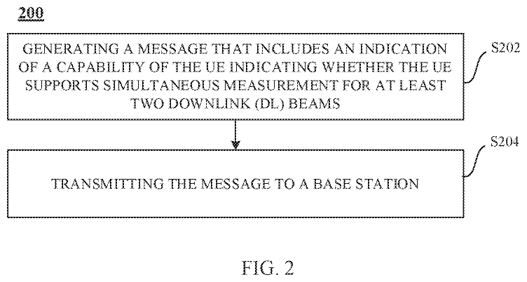

FIG. 2 illustrates a flowchart of an example process 200 for indicating a UE capability on a UE side, in accordance with some embodiments.

At step S202, the UE may generate a message that includes indication of a capability of the UE indicating whether the UE supports simultaneous measurement for at least two downlink (DL) beams. At step S204, the UE may transmit the message to a base station as a report of the capability of the UE when accessing the base station.

According to some embodiments of the present disclosure, the UE may report a capability indicating the support of at least two concurrent DL beams to a base station (e.g., a gNB). The support of the at least two concurrent DL beams may be implemented by at least two active antenna arrays of the UE. Herein, the DL beams are in FR2, or any other frequency range m mmWave. In some examples, the support of at least two concurrent DL beams can also be referred to as simultaneous multiple panels operation, simultaneous multiple beams operation, etc.

In some embodiments, the indication may include a single bit indicating a general capability of the UE that the UE supports at least two simultaneous active DL beams. The at least two active DL beams can be used for a plurality of functionalities such as Radio Resource Management (RRM), Radio Link Management (RLM), beam management and data transmission. In case that a value of the bit is “1”, the message may indicate that the UE supports at least two simultaneous active DL beams. In case that the value of the bit is “0”, the message may indicate that the UE does not support at least two simultaneous active DL beams. It is understandable that those skilled in the art can set any other value or symbol for the indication to define the capability of the UE. In this way, a general capability is defined for the UE. If the UE indicates this capability, the UE shall support multiple concurrent DL beams.

In some embodiments, the indication may include a plurality of bits. Each of the plurality of bits may indicate that the DL beams are measured for one of a plurality of functionalities. In some implementations, the plurality of functionalities may include RRM, RLM, beam management and data transmission. Beam management includes beam failure detection (BFD), candidate beam detection (CBD) and L1-RSRP/SINR measurement. For example, the indication may include four bits. The 18 bit is used for indicating that the UE supports measurement for at least two DL beams for RRM, and the 210 bit, 310 bit and the 40 bit are used for indicating that the UE supports measurement for at least two DL beams for RLM, beam management and data transmission, respectively. It is understandable that those skilled in the art can set the definition of the plurality of bits according to actual situation. In this way, several capabilities are defined for the UE. Each of the capabilities can be defined for different functionality.

In some embodiments, the indication may include a bit indicating a number of simultaneous active beams (simultaneous active transmission configuration index (TCI)) supported by the UE. That is, the indication may indicate how may DL beams can be measured simultaneously by the UE. If the actual number of active beams (active TCI) is smaller than the number of supported by the UE's, the UE may perform fast measurement.

The capabilities defined for the UE in the message as described above may be used either alone or in combination. For example, the indication may include one bit indicating a general capability of the UE that the UE supports at least two simultaneous active DL beams, and another bit indicating a number of simultaneous active beams supported by the UE. For another example, the indication may include a plurality of bits each of which indicates that the DL beams are measured for one of a plurality of functionalities, and a further bit indicating a number of simultaneous active beams supported by the UE. The above examples do not limit the scope of the present disclosure and those skilled in the art may defined the capability of the UE according to actual situations.

In some embodiments, the capabilities defined for the UE in the message as described above may be indicated per band combination (BC), per carrier or per UE.

In some implementations, the capabilities may be indicated per UE and per band of band combination by indicating different capabilities for different BC. For example, A primary cell (PCell) and a neighbor cell 1 is on band A while a neighbor cell 2 is on band B. The capability of the UE may indicate that the UE supports simultaneous measurement for at least two DL beams on cell 1 (on band A) or on both call 1 and cell 2 (on both band A and band B). In an example, the indication may include a bit indicating whether the UE supports simultaneous measurement for at least two DL beams on band A. In another example, the indication may include a bit indicating whether the UE supports simultaneous measurement for at least two DL beams on band A+B.

In some implementations, the capabilities may be indicated per carrier by indicating different capabilities on different carriers, even the carriers are in the same band.

In some implementations, the capabilities may be indicated per UE by indicating that same capability applies to all the serving cells for the UE. For example, the message may indicate that same capability applies to all serving cells in mmWave for the UE.

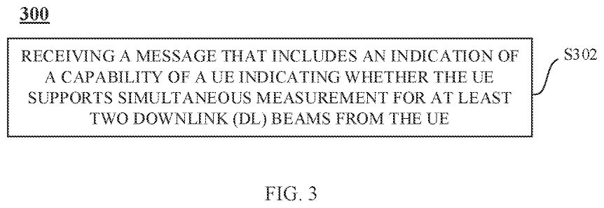

FIG. 3 illustrates a flowchart of an example process 300 for indicating a UE capability on a base station side, in accordance with some embodiments.

At step S302, the base station may receive a message that includes an indication of a capability of a UE indicating whether the UE supports simultaneous measurement for at least two downlink (DL) beams from the UE.

As illustrated in FIG. 3, the base station may receive a report indicating a capability of the UE. Herein, the DL beams are in FR2, or any other frequency range in mmWave.

In some embodiments, the indication may include a single bit indicating a general capability of the UE that the UE supports at least two simultaneous active DL beams. The at least two active DL beams can be used for a plurality of functionalities such as Radio Resource Management (RRM), Radio Link Management (RLM), beam management and data transmission. It is understandable that those skilled in the art can set any other value or symbol for the indication to define the capability of the UE. In this way, a general capability is defined for the UE. If the UE indicates this capability, the UE shall support multiple concurrent DL beams.

In some embodiments, the indication may include a plurality of bits. Each of the plurality of bits may indicate that the DL beams are measured for one of a plurality of functionalities. In some implementations, the plurality of functionalities may include RRM, RLM, beam management and data transmission.

In some embodiments, the indication may include a bit indicating a number of simultaneous active beams (simultaneous active transmission configuration index (ICI) supported by the UE.

The capabilities defined for the UE in the message as described above may be used either alone or in combination. For example, the indication may include one bit indicating a general capability of the UE that the UE supports at least two simultaneous active DL beams, and another bit indicating a number of simultaneous active beams supported by the UE. For another example, the indication may include a plurality of bits each of which indicates that the DL beams are measured for one of a plurality of functionalities, and a further bit indicating a number of simultaneous active beams supported by the UE. The above examples do not limit the scope of the present disclosure and those skilled in the art may defined the capability of the UE according to actual situations.

In some embodiments, the capabilities defined for the UE in the message as described above may be indicated per band combination (BC), per carrier or per UE.

In some implementations, the capabilities may be indicated per UE and per band of band combination by indicating different capabilities for different BC.

In some implementations, the capabilities may be indicated per carrier by indicating different capabilities on different carriers, even the carriers are in the same band.

In some implementations, the capabilities may be indicated per UE by indicating that same capability applies to all the serving cells for the UE. For example, the message may indicate that same capability applies to all serving cells in mmWave for the UE.

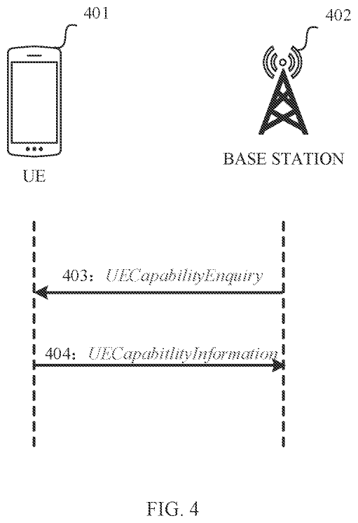

FIG. 4 illustrates a communication exchange between the UE and the base station, in accordance with some embodiments.

As shown in FIG. 4, the report of the capabilities of the UE involves two operations. At operation 403, the base station 402 may transmit a UECapabilityEnquiry message to the UE 401, to request a report of the capabilities of the UE. At operation 404, in response to reception of the UECapabilityEnquiry message, the UE may transmit a UECapabilityInformation message to the base station 402, to report the capabilities of the UE. The UECapabilityInformation message may include the indication of a capability of the UE indicating whether the UE supports simultaneous measurement for at least two downlink (DL) beams as described with reference to FIG. 2.

According to some aspects of the present disclosure, a new UE capability is introduced. Since the beam measurement may be performed with at least two DL beams concurrently, the latency due to beam sweeping can be significantly reduced. Therefore, fast measurement may be implemented and performance with for UEs with high mobility may be improved

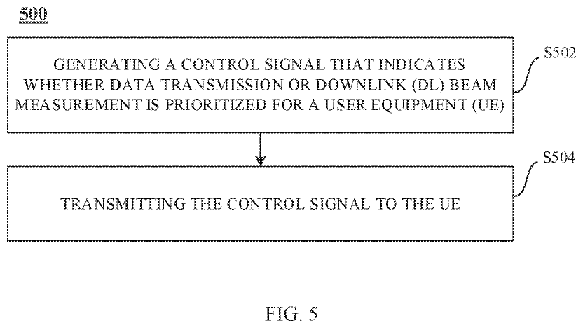

FIG. 5 illustrates a flowchart of an example process 500 for controlling measurement of a UE on a base station side, in accordance with some embodiments.

At step S502, the base station may generate a control signal that indicates whether data transmission or downlink (DL) beam measurement is prioritized for a user equipment (UE). At step S504, the base station may transmit the control signal to the UE.

Based on the control signal generated by the base station, the network may choose whether the at least two beams supported by the UE are used for data transmission or DL beam measurement.

In some embodiments, the control signal may indicate that data transmission is prioritized for the UE or DL beam measurement is prioritized for the UE with a bit with different values.

In some implementations, the control signal may include a bit with a first value (e.g., 0) that indicates that the one of the DL beams is fixed for data transmission. In this way, data transmission is prioritized for the UE. In some examples, data transmission may be prioritized for a stationary UE or huge data demand between the UE and the base station. When data transmission is prioritized, the network does not need to follow scheduling restriction and measurement restriction defined in TS 38.133 sections 8.1.7, 8.5 and 9.

In some implementations, the control signal may include a bit with a second value (e.g., 1) that indicates that all of the DL beams are used for simultaneous measurement. In this way, DL beam measurement is prioritized for the UE. In some examples, DL beam measurement may be prioritized for a high mobility UE.

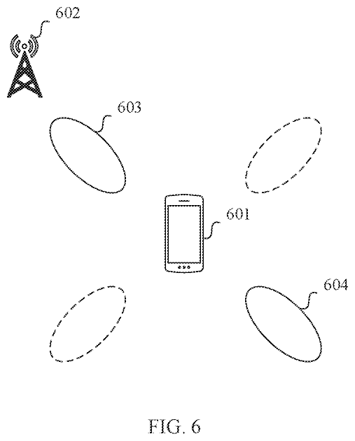

FIG. 6 illustrates an example scene where data transmission is prioritized for the UE.

As shown in FIG. 6, the UE 601 supports two DL beams simultaneously. Since data transmission is prioritized, a first beam 603 is fixed for data transmission between the UE 601 and the serving cell 602. At the meantime, a second beam 604 is used for DL beam measurement.

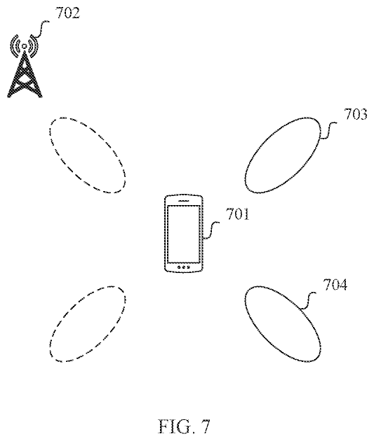

FIG. 7 illustrates an example scene where DL beam measurement is prioritized for the UE.

As shown in FIG. 7, the UE 701 supports two DL beams simultaneously. Since DL beam measurement is prioritized, a first beam 703 and a second beam 704 are both used for DL beam measurement in two different direction. In the example scene shown in FIG. 7, data transmission between the UE 701 and the serving cell 702 are interrupted temporarily.

Although FIG. 6 and FIG. 7 show examples of a UE supporting two DL beams simultaneously, the scope of the present disclosure is not limited thereto. In some embodiments, the UE may support three or more DL beams simultaneously. In case that the UE may support three or more DL beams, the control signal may further include indication that indicates a number of fixed beams for data transmission.

In some embodiments, the control signal may be transmitted through at least one of: system broadcast information, dedicated Radio Resource Control (RRC) signaling, Media Access Control (MAC) command, or Downlink Control Information (DCI) command. Herein, the system broadcast information may be used for UE in connected mode, idle mode or inactive mode. In some examples, the system broadcast information may be used in a high mobility scene such as a high speed train network. Mobility is considered with high priority in this situation. Therefore, the control signal may be transmitted via broadcast to all UEs even the UE is in idle/inactive mode.

The dedicated RRC signaling, MAC command, and DCI command may be used for UE in connected mode. For example, the control signal for controlling beam measurement of UE may be transmitted via dedicated RRC in either RRC configuration or reconfiguration. In another example, the control signal for controlling beam measurement of UE may be transmitted via MAC command or via DCI command to allow change based on different scenarios.

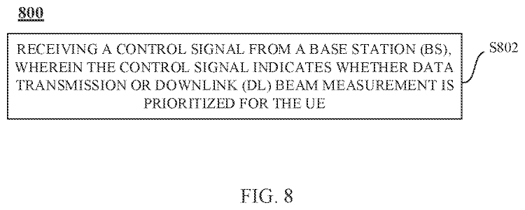

FIG. 8 illustrates a flowchart of an example process 800 for controlling measurement of a UE on a UE side, in accordance with some embodiments.

At step S802, the UE may receive a control signal from a base station (BS), wherein the control signal indicates whether data transmission or downlink (DL) beam measurement is prioritized for the UE.

In some embodiments, the control signal may indicate that data transmission is prioritized for the UE or DL beam measurement is prioritized for the UE with a bit with different values.

In some implementations, the control signal may include a bit with a first value (e.g., 0) that indicates that the one of the DL beams is fixed for data transmission. In this way, data transmission is prioritized for the UE. In some examples, data transmission may be prioritized for a stationary UE or huge data demand between the UE and the base station. When data transmission is prioritized, the network does not need to follow scheduling restriction and measurement restriction defined in TS 38.133 sections 8.1.7, 8.5 and 9.

In some implementations, the control signal may include a bit with a second value (e.g., 1) that indicates that all of the DL beams are used for simultaneous measurement. In this way, DL beam measurement is prioritized for the UE. In some examples, DL beam measurement may be prioritized for a high mobility UE.

In some embodiments, the control signal may be received through at least one of: system broadcast information, dedicated Radio Resource Control (RRC) signaling. Media Access Control (MAC) command, or Downlink Control Information (ICI) command.

According to some aspects of the present disclosure, the network may configure the working mode of the UE which supports multiple concurrent beams. Since the beam measurement may be performed with at least two DL beams concurrently, the latency due to beam sweeping can be significantly reduced. Therefore, fast measurement may be implemented and performance with for UEs with high mobility may be improved

The fast measurement method provided by the present disclosure may be used for different scenarios, including but not limited to at least one of intra-frequency measurement and inter-frequency measurement. For example, the fast measurement method may be used in at least one of intra-frequency measurement without gap, intra-frequency measurement with gap, inter-frequency measurement without gap, and inter-frequency measurement with gap.

According to some embodiments of the present application, the scaling factor of required time for a cell detection time, a measurement interval or a cell evaluation time for cell reselection in idle/inactive mode may be smaller than legacy scaling factor for FR2.

Following shows legacy requirements for measurements of intra-frequency NR cells defined in table 4.2.2.3-1 in TS 38 133:

TABLE 4.2.2.3-1
T_{detect, NR}_{_{—}}_{Intra}, T_{measure, NR}_{_{—}}_{Intra} and T_{evaluate, NR}_{_{—}}_{Intra}

| DRX | Scaling | | | | |
|---|---|---|---|---|---|
| cycle | Factor | | T_{detect, NR}_{_{—}}_{Intra} [s] | T_{measure, NR}_{_{—}}_{Intra} [s] | T_{evaluate, NR}_{_{—}}_{Intra} [s] |
| length | (N1) | | (number of | (number of | (number of |
| [s] | FR1 | FR2^{Note1} | DRX cycles) | DRX cycles) | DRX cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 (28 × N1) | 1.28 × N1 (2 × N1) | 5.12 × N1 (8 × N1) |
| 1.28 | | 4 | 32 × N1 (25 × N1) | 1.28 × N1 (1 × N1) | 6.4 × N1 (5 × N1) |
| 2.56 | | 3 | 58.88 × N1 (23 × N1) | 2.56 × N1 (1 × N1) | 7.68 × N1 (3 × N1) |

^{Note1}
Applies for UE supporting power class 2&3&4. For UE supporting power class 1, N1 = 8 for all DRX cycle length.
Note 2:
M2 = 1.5 if SMTC periodicity of measured intra-frequency cell >20 ms; otherwise M2 = 1.

As defined in TS 38.133 section 4.2.2.3, the UE shall be able to evaluate whether a newly detectable intra-frequency cell meets the reselection criteria defined in TS 38.304 [1] within a cell detection time T_{detect,NR_intra}. The UE shall measure SS-RSRP (Synchronization Signal based Reference Signal Received Power) and SS-RSRQ (Synchronization Signal based Reference Signal Received Quality) at least every measurement interval T_{measure,NR_intra} for intra-frequency cells that are identified and measured according to the measurement rules. The UE shall filter SS-RSRP and SS-RSRQ measurements of each measured intra-frequency cell using at least 2 measurements. Within the set of measurements used for the filtering, at least two measurements shall be spaced by at least T_{measure,NR_intra}/2. For an intra-frequency cell that has been already detected, but that has not been reselected to, the filtering shall be such that the UE shall be capable of evaluating that the intra-frequency cell has met reselection criterion defined in TS 38.304 [1] within the cell evaluation time T_{evaluate,NR_intra}.

As can be seen from Table 4.2.2.3-1, the scaling factors of NI for FR2 is 8 for a DRX cycle length 0.32 s, 5 for a DRX cycle length 0.64 s, 4 for a DRX cycle length 1.28 s, and 3 for a DRX cycle length 2.56 s for the cell detection time T_{detect,NR_intra}, the measurement interval T_{measure,NR_intra} or the cell evaluation time T_{evaluate,NR_intra}.

For a UE supporting simultaneous measurement for at least two DL beams, since at least two beams can be measured simultaneously, the time for measurement can be reduced.

Table 1 describes a requirement for the cell detection time There, NR mm, the measurement interval T_{measure,NR_intra} of the cell evaluation time T_{evaluate,NR_intra} according to some embodiments of the present disclosure.

TABLE 1

| DRX | Scaling | | | | |
|---|---|---|---|---|---|
| cycle | Factor | | T_{detect, NR}_{_{—}}_{Intra} [s] | T_{measure, NR}_{_{—}}_{Intra} [s] | T_{evaluate, NR}_{_{—}}_{Intra} [s] |
| length | (N1) | | (number of | (number of | (number of |
| [s] | FR1 | FR2^{Note1} | DRX cycles) | DRX cycles) | DRX cycles) |
| 0.32 | 1 | Y1 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | Y2 | 17.92 × N1 (28 × N1) | 1.28 × N1 (2 × N1) | 5.12 × N1 (8 × N1) |
| 1.28 | | Y3 | 32 × N1 (25 × N1) | 1.28 × N1 (1 × N1) | 6.4 × N1 (5 × N1) |
| 2.56 | | Y4 | 58.88 × N1 (23 × N1) | 2.56 × N1 (1 × N1) | 7.68 × N1 (3 × N1) |

^{Note1}
Applies for UE supporting power class 2&3&4. For UE supporting power class 1, N1 = Y1 for all DRX cycle length.
Note 2:
M2 = 1.5 if SMTC periodicity of measured intra-frequency cell >20 ms; otherwise M2 = 1.

As shown in Table 1, the legacy scaling factors of NI can be replaced by a different set of parameters Y1, Y2, Y3, and Y4. Herein, Y1 is used for the DRX cycle length 0.32 s, Y2 is used for the DRX cycle length 0.64 s, Y3 is used for the DRX cycle length 1.28 s, and Y4 is used for the DRX cycle length 1.28 s. It is understandable that the scaling factors Y1-Y4 described in Table 1 are applicable for any frequency range in mmWave in addition to FR2.

Since the time required for measurements is reduced by simultaneous measurement for DL beams, the scaling factors Y1 may be smaller than the legacy value of 8 defined in Table 4.2.2.3-1 in TS 38.133. Similarly, Y2 may be smaller than the legacy value of 5, Y3 may be smaller than the legacy value of 4, and Y4 may be smaller than the legacy value of 3 as defined in Table 4.2.2.3-1 in TS 38.133.

In some implementations, the value of the scaling factors Y1-Y4 may be determined based on the number of the DL beams which are supported for simultaneous measurement. Particularly, in case that the UE support simultaneous measurement for 2 DL beams, the scaling factors may be defined as follows to replace the legacy scaling factors of N1: Y1=4, Y2=3, Y3=2, Y4=2.

Similarly, the legacy scaling factors of NI for FR2 defined in table 4.2.2.4-1 in TS 38.133 for measurements of inter-frequency NR cells may be replaced by a different set of parameters Y1, Y2, Y3, and Y4, wherein Y1 may be smaller than the legacy value of 8, Y2 may be smaller than the legacy value of 5, Y3 may be smaller than the legacy value of 4, and Y4 may be smaller than the legacy value of 3 as defined in Table 4.2.2.4-1 in TS 38.133.

In some implementations, if the UE reports a capability indicates that the UE supports simultaneous measurement for at least two DL beams, the behavior of UE may be fixed. That is, the UE may perform measurement with multiple concurrent DL beams. The scaling factors Y1-Y4 as defined in Table 1 will apply.

In other implementations, if the network transmits a control signal as described with reference 1 FIGS. 5-8 to control the measurement performance of the UE, the UE may follow legacy scaling factors (e.g., NI as defined in Table 4.2.2.3-1 or Table 4.2.2.4-1 in TS 38.133) in response to a determination that the control signal transmitted from the base station to the UE includes the bit with the first value. On the other hand, the UE may perform measurement with at least two DL beams and apply the scaling factors Y1-Y4 as defined in Table 1 in response to a determination that the control signal transmitted from the base station to the UE includes the bit with the second value.

According to some embodiments of the present disclosure, a time required to search a target cell when a handover command is received by the UE is shorter than a legacy time required to search a target cell for FR2.

As defined in TS 38.133 section 6.1.1.4 for NR FR2-NR FR2 handover, an interruption time is defined as time between end of the last TTI containing the RRC command on the old PDSCH and the time the UE starts transmission of the new PRACH, excluding the RRC procedure delay. When intra-frequency or inter-frequency handover is commanded, the interruption time shall be shorter than Tᵢₙₜₑᵣᵣᵤₚₜ.

Tᵢₙₜₑᵣᵣᵤₚₜ=T_{search}+T_{IU}+T_{processing}+T_{Δ}+T_{margin ms}

### Where:

T_{search} is the time required to search the target cell when the handover command is received by the UE. If the target cell is a known cell, then T_{search}=0 ms. If the target cell is an unknown intra-frequency cell and the target cell Es/Iot≥−2 dB, then T_{search}=8*Tᵣₛ ms. If the target cell is an unknown inter-frequency cell and the target cell Es/Iot≥−2 dB, then T_{search}=8*3*Tᵣₛ ms. Regardless of whether DRX is in use by the UE, T_{search} shall still be based on non-DRX target cell search times.
T_{processing} is time for UE processing. T_{processing} can be up to 20 ms.

T_{margin} is time for SSB post-processing. T_{margin} can be up to 2 ms.

T_{Δ} is time for fine time tracking and acquiring full timing information of the target cell. T_{Δ}=Tᵣₛ for both known and unknown target cell.
T_{IU} is the interruption uncertainty in acquiring the first available PRACH occasion in the new cell. T_{IU} can be up to the summation of SSB to PRACH occasion association period and 10 ms. SSB to PRACH occasion associated period is defined in the table 8.1-1 of TS 38.213 [3].

Tᵣₛ is the SMTC periodicity of the target NR cell if the UE has been provided with an SMTC configuration for the target cell in the handover command, otherwise Tᵣₛ is the SMTC configured in the measObjectNR having the same SSB frequency and subcarrier spacing.

As can be seen, the time required to search the target cell when the handover command is received by the UE is defined by Tᵣₛ multiplied by a factor of “8” if the target cell is an unknown intra-frequency cell and the target cell Es/Iot2≥−2 dB. If the target cell is an unknown inter-frequency cell and the target cell Es/Iot≥−2 dB, the time required to search the target cell when the handover command is received by the UE is defined by 3*Tᵣₛ multiplied by a factor of “8”.

For a UE supporting simultaneous measurement for at least two DL beams, since at least two beams can be measured simultaneously, the time required to search the target cell can be reduced.

In particular, the factor for determining T_{search} can be replaced by a different parameter Y for a UE supporting simultaneous measurement for at least two DL beams. The value of Y may be smaller than legacy factor of 8 as defined in TS 38.133 section 6.1.1.4.2.

In some implementations, the value of the factor for determining T_{search} may be determined based on the number of the DL beams which are supported for simultaneous measurement. Particularly, in case that the UE support simultaneous measurement for 2 DL beams, the factor for determining T_{search} may be set to 4. That is, the time required to search a target cell when a handover command is received by the UE is half of the legacy time required to search a target cell for FR2.

Similarly, the time required to search a target cell when a handover command is received by the UE for NR FR1-NR FR2 handover may be replaced by a different time, wherein the different time period required to search a target cell is shorter than the legacy time T_{search} as defined in TS 38.133 section 6.1.1.5.2.

In some implementations, if the UE reports a capability indicates that the UE supports simultaneous measurement for at least two DL beams, the behavior of UE may be fixed. That is, the UE may perform measurement with multiple concurrent DL beams. The factor Y as defined above will apply.

In other implementations, if the network transmits a control signal as described with reference 1 FIGS. 5-8 to control the measurement performance of the UE, the UE may follow legacy T_{search} (e.g. T_{search} as defined in TS 38.133 section 6.1.1.4.2 or section 6.1.1.5.2) in response to a determination that the control signal transmitted from the base station to the UE includes the bit with the first value. On the other hand, the UE may perform measurement with at least two DL beams and apply the factor Y as defined above in response to a determination that the control signal transmitted from the base station to the UE includes the bit with the second value.

According to some embodiments of the present disclosure, a time period used in PSS/SSS detection is shorter than a legacy time period used in PSS/SSS detection for FR2.

The legacy time period for PSS/SSS detection for FR2 is defined in table 9.2.5.1-2 in TS 38.133 as below:

TABLE 9.2.5.1-2
Time period for PSS/SSS detection, (Frequency range FR2)

| DRX cycle | T_{PSS/SSS}_{_{—}}_{sync}_{_{—}}ᵢₙₜᵣₐ |
|---|---|
| No DRX | max(600 ms, ceil(M_{pss/sss}_{_{—}}_{sync}_{_{—}}_{w/o}_{_{—}}_{gaps} × Kₚ × |
| | K_{layer1}_{_{—}}ₘₑₐₛᵤᵣₑₘₑₙₜ) × SMTC period)^{Note 1} × |
| | CSSFᵢₙₜᵣₐ |
| DRX cycle ≤320 ms | max(600 ms, ceil(1.5 × M_{pss/sss}_{_{—}}_{sync}_{_{—}}_{w/o}_{_{—}}_{gaps} × |
| | Kₚ × K_{layer1}_{_{—}}ₘₑₐₛᵤᵣₑₘₑₙₜ) × max(SMTC period, |
| | DRX cycle)) × CSSFᵢₙₜᵣₐ |
| DRX cycle >320 ms | ceil(M_{pss/sss}_{_{—}}_{sync}_{_{—}}_{w/o}_{_{—}}_{gaps} × Kₚ × |
| | K_{layer1}_{_{—}}ₘₑₐₛᵤᵣₑₘₑₙₜ) × DRX cycle × CSSFᵢₙₜᵣₐ |

^{Note 1}
If different SMTC periodicities are configured for different cells, the SMTC period in the requirement is the one used by the cell being identified

The legacy time period used in PSS/SSS detection for FR2 is defined based on a legacy parameter M_{pss/sss_sync_w/o_gaps}, which is used to control the measurement delay. For a UE supporting FR2 power class 1, M_{pss/sss_sync_w/o_gaps}=40. For a UE supporting power class 2. M_{pss/sss_sync_w/o_gaps}=24. For a UE supporting FR2 power class 3, M_{pss/sss_sync_w/o_gaps}=24. For a UE supporting FR2 power class 4, M_{pss/sss_sync_w/o_gaps}==24.

For a UE supporting simultaneous measurement for at least two DL beams, since at least two beams can be measured simultaneously, the time period for PSS/SSS detection can be reduced.

Table 2 describes a requirement for the time period for PSS/SSS detection according to some embodiments of the present disclosure.

TABLE 2

| DRX cycle | T_{PSS/SSS}_{_{—}}_{sync}_{_{—}}ᵢₙₜᵣₐ |
|---|---|
| No DRX | max(600 ms, ceil(N × Kₚ × K_{layer1}_{_{—}}ₘₑₐₛᵤᵣₑₘₑₙₜ) × |
| | SMTC period)^{Note 1} × CSSFᵢₙₜᵣₐ |
| DRX cycle ≤320 ms | max(600 ms, ceil(1.5 × N × Kₚ × |
| | K_{layer1}_{_{—}}ₘₑₐₛᵤᵣₑₘₑₙₜ) × max(SMTC period, |
| | DRX cycle)) × CSSFᵢₙₜᵣₐ |
| DRX cycle >320 ms | ceil(N × Kₚ × K_{layer1}_{_{—}}ₘₑₐₛᵤᵣₑₘₑₙₜ) × |
| | DRX cycle × CSSFᵢₙₜᵣₐ |

^{Note 1}
If different SMTC periodicities are configured for different cells, the SMTC period in the requirement is the one used by the cell being identified

As shown in Table 2, the legacy parameter M_{pss/sss_sync_w/o_gaps} may be replaced by a new parameter N for determining the time period for PSS/SSS detection. In particular, the value of N is smaller than the legacy parameter M_{pss/sss_sync_w/o_gaps}. For example, for a UE supporting FR2 power class 1, N may be smaller than 40. For a UE supporting FR2 power class 2, power class 3, or power class 4, N may be smaller than 12.

Particularly, in case that the UE support simultaneous measurement for 2 DL beams, the parameter N as defined in Table 2 may be set to N=20 for a UE supporting power class 1, and N=12 for a UE supporting power class 2, power class 3, or power class 4.

In some implementations, if the UE reports a capability indicates that the UE supports simultaneous measurement for at least two DL beams, the behavior of UE may be fixed. That is, the UE may perform measurement with multiple concurrent DL beams. The parameter N as defined in Table 2 will apply.

In other implementations, if the network transmits a control signal as described with reference 1 FIGS. 5-8 to control the measurement performance of the UE, the UE may follow legacy parameter M_{pss/sss_sync_w/o_gaps} (e.g., parameter M_{pss/sss_sync_w/o_gaps} as defined in Table 9.2.5.1-2 m TS 38.133 section) in response to a determination that the control signal transmitted from the base station to the UE includes the bit with the first value. On the other hand, the UE may perform measurement with at least two DL beams and apply parameter N as defined in Table 2 in response to a determination that the control signal transmitted from the base station to the UE includes the bit with the second value.

According to principle of the present disclosure, fast measurement may be performed for different scenarios in addition to the examples illustrated above.

In some embodiments, legacy time index detection time defined in Table 9.2.5.1-5 in TS 38.133 may be shortened by replacing legacy parameter M_{pss/sss_sync_w/o_gaps} with a different parameter which is smaller than legacy M_{pss/sss_sync_w/o_gaps} we gaps. Similarly, legacy time index detection time defined in Table 9.2.6.2-2 in TS 38.133 may be shortened by replacing legacy parameter M_{pss/sss_sync_w/o_gaps} with a different parameter which is smaller than legacy M_{pss/sss_sync_w/o_gaps}. Similarly, legacy time index detection time defined in Table 9.3.4-2 m TS 38.133 may be shortened by replacing legacy parameter M_{pss/sss_sync_inter} with a different parameter which is smaller than legacy M_{pss/sss_sync_inter}. Similarly, legacy time index detection time defined in Table 9.3.4.4 m TS 38.133 may be shortened by replacing legacy parameter Mass index ter with a different parameter which is smaller than legacy M_{SSB_index_inter}.

In some embodiments, measurement period defined in Table 9.2.5.2-2, in TS 38.133 may be shortened by replacing legacy parameter M_{pss/sss_sync_w/o_gaps} with a different parameter which is smaller than legacy M_{pss/sss_sync_w/o_gaps}. Similarly, measurement period defined in Table 9.2.6.3-2 in TS 38.133 may be shortened by replacing legacy parameter M_{pss/sss_sync_w/o_gaps} with a different parameter which is smaller than legacy M_{pss/sss_sync_w/o_gaps}. Similarly, measurement period defined in Table 9.3.9-2 may be shortened by replacing legacy parameter M_{meas_period_inter} with a different parameter which is smaller than legacy M_{meas_period_inter}. Similarly, measurement period defined in Table 9.3.5-2 may be shortened by replacing legacy parameter M_{meas_period_inter} with a different parameter which is smaller than legacy M_{meas_period_inter}.

Furthermore, the fast measurement provided by the present disclosure may be extended to other measurement type including but not limited to: CSI-RS based RRM measurement, L1-RSRP measurement, or L1-SINR measurement.

In some examples, the measurement period as defined in Table 9.10.2.5-2 in TS 38.133 may be shortened by replacing legacy parameter M_{meas_period_w/o_gaps} with a different parameter which is smaller than legacy M_{meas_period_w/o_gaps}, Similarly, measurement period defined in Table 9.10.3.5-2 may be shortened by replacing legacy parameter M_{meas_period_inter} with a different parameter which is smaller than legacy M_{meas_period_inter}.

In some examples, the measurement period as defined in Table 9.5.4.1-2 in TS 38.133 may be shortened by replacing legacy parameter N with a different parameter which is smaller than legacy N. Similar replacement may also be applied to legacy parameters N defined in Table 9.5.4.2-2, Table 9.8.4.1-2, Table 9.8.4.2-2, Table 9.8.4.3-2 in TS 38.133.

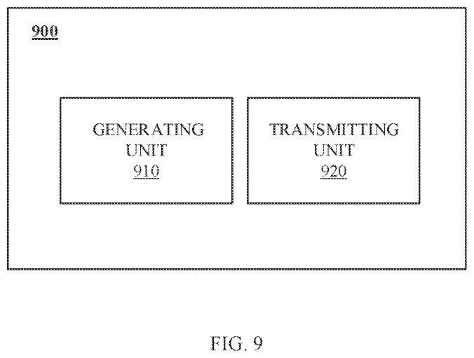

FIG. 9 illustrates an exemplary block diagram of an apparatus 900 for a user equipment in accordance with some embodiments. The apparatus 900 illustrated in FIG. 9 may be used to implement the method 200 as illustrated in combination with FIG. 2.

As illustrated in FIG. 9, the apparatus 900 may include a generating unit 910 and a transmitting unit 920.

The generating unit 910 may be configured to generate a message that includes an indication of a capability of the UE indicating whether the UE supports simultaneous measurement for at least two downlink (DL) beams.

The transmitting unit 920 may be configured to transmit the message to a base station.

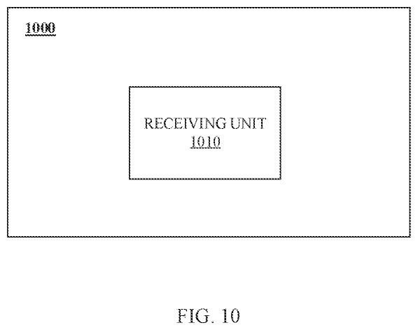

FIG. 10 illustrates an exemplary block diagram of an apparatus 1000 for a user equipment in accordance with some embodiments. The apparatus 1000 illustrated in FIG. 10 may be used to implement the method 800 as illustrated in combination with FIG. 8.

As illustrated in FIG. 10, the apparatus 1000 may include a receiving unit 1010. The receiving unit 1010 may be configured to receive a control signal from a base station (BS), wherein the control signal indicates whether data transmission or downlink (DL) beam measurement is prioritized for the UE.

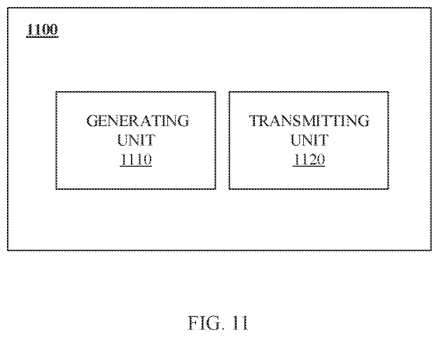

FIG. 11 illustrates an exemplary block diagram of an apparatus 1100 for a base station in accordance with some embodiments. The apparatus 1100 illustrated in FIG. 11 may be used to implement the method 500 as illustrated in combination with FIG. 5.

As illustrated in FIG. 11, the apparatus 1100 may include a generating unit 1110 and a transmitting unit 1120.

The generating unit 1110 may be configured to generate a control signal that indicates whether data transmission or downlink (DL) beam measurement is prioritized for a user equipment (UE).

The transmitting unit 1120 may be configured to transmit the control signal to the UE.

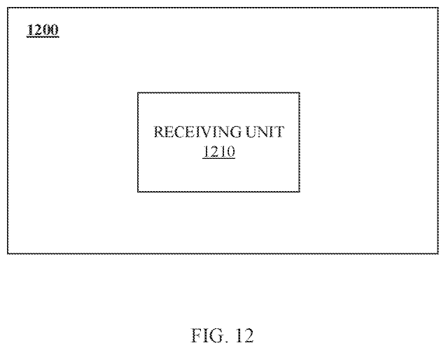

FIG. 12 illustrates an exemplary block diagram of an apparatus 1200 for a user equipment in accordance with some embodiments. The apparatus 1200 illustrated in FIG. 12 may be used to implement the method 300 as illustrated in combination with FIG. 3.

As illustrated in FIG. 12, the apparatus 1200 may include a receiving unit 1210. The receiving unit 1210 may be configured to receiving a message that includes an indication of a capability of a UE indicating whether the UE supports simultaneous measurement for at least two downlink (DL) beams from the UE.

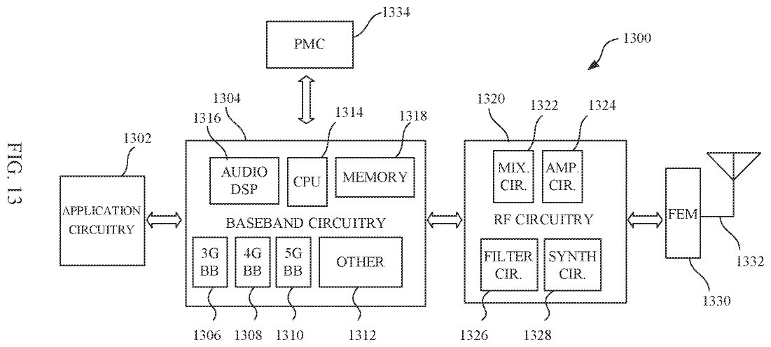

FIG. 13 illustrates example components of a device 1300 in accordance with some embodiments. In some embodiments, the device 1300 may include application circuitry 1302, baseband circuitry 1304, Radio Frequency (RF) circuitry (shown as RF circuitry 1320), front-end module (FEM) circuitry (shown as FEM circuitry 1330), one or more antennas 1332, and power management circuitry (PMC) (shown as PMC 1334) coupled together at least as shown. The components of the illustrated device 1300 may be included in a UE or a RAN node. In some embodiments, the device 1300 may include fewer elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300, In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1320 and to generate baseband signals for a transmit signal path of the RF circuitry 1320. The baseband circuitry 1304 may interface with the application circuitry 1302 for generation and processing of the baseband signals and for controlling operations of the RF circuitry 1320. For example, in some embodiments, the baseband circuitry 1304 may include a third generation (3G) baseband processor (3G baseband processor 1306), a fourth generation (4G) baseband processor (4G baseband processor 1308), a fifth generation (5G) baseband processor (5G baseband processor 1310), or other baseband processor(s) 1312 for other existing generations, generations in development or to be developed in the future (e.g., second generation (2G), sixth generation (6G), etc.). The baseband circuitry 1304 (e.g., one or more of baseband processors) may handle various radio control functions that enable communication with one or more radio networks via the RF circuitry 1320. In other embodiments, some or all of the functionality of the illustrated baseband processors may be included in modules stored in the memory 1318 and executed via a Central Processing ETnit (CPET 1314). The radio control functions may include, but are not limited to, signal modulation/demodulation, encoding/decoding, radio frequency shifting, etc. In some embodiments, modulation/demodulation circuitry of the baseband circuitry 1304 may include Fast Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include a digital signal processor (DSP), such as one or more audio DSP(s) 1316. The one or more audio DSP(s) 1316 may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1304 and the application circuitry 1302 may be implemented together such as, for example, on a system on a chip (SOC).

In some embodiments, the baseband circuitry 1304 may provide for communication compatible with one or more radio technologies. For example, in some embodiments, the baseband circuitry 1304 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1304 is configured to support radio communications of more than one wireless protocol may be referred to as multi-mode baseband circuitry.

The RF circuitry 1320 may enable communication with wireless networks using modulated electromagnetic radiation through a non-solid medium. In various embodiments, the RF circuitry 1320 may include switches, filters, amplifiers, etc. to facilitate the communication with the wireless network. The RF circuitry 1320 may include a receive signal path which may include circuitry to down-convert RF signals received from the FEM circuitry 1330 and provide baseband signals to the baseband circuitry 1304. The RF circuitry 1320 may also include a transmit signal path which may include circuitry to up-convert baseband signals provided by the baseband circuitry 1304 and provide RF output signals to the FEM circuitry 1330 for transmission. In some embodiments, the receive signal path of the RF circuitry 1320 may include mixer circuitry 1322, amplifier circuitry 1324 and filter circuitry 1326. In some embodiments, the transmit signal path of the RF circuitry 1320 may include filter circuitry 1326 and mixer circuitry 1322. The RF circuitry 1320 may also include synthesizer circuitry 1328 for synthesizing a frequency for use by the mixer circuitry 1322 of the receive signal path and the transmit signal path. In some embodiments, the mixer circuitry 1322 of the receive signal path may be configured to down-convert RF signals received from the FEM circuitry 1330 based on the synthesized frequency provided by synthesizer circuitry 1328. The amplifier circuitry 1324 may be configured to amplify the down-converted signals and the filter circuitry 1326 may be a low pass filter (LPF) or band-pass filter (BPF) configured to remove unwanted signals from the down-converted signals to generate output baseband signals. Output baseband signals may be provided to the baseband circuitry 1304 for further processing. In some embodiments, the output baseband signals may be zero-frequency baseband signals, although this is not a requirement. In some embodiments, the mixer circuitry 1322 of the receive signal path may comprise passive mixers, although the scope of the embodiments is not limited in this respect.

In some embodiments, the mixer circuitry 1322 of the transmit signal path may be configured to up-convert input baseband signals based on the synthesized frequency provided by the synthesizer circuitry 1328 to generate RF output signals for the FEM circuitry 1330. The baseband signals may be provided by the baseband circuitry 1304 and may be filtered by the filter circuitry 1326.

In some embodiments, the mixer circuitry 1322 of the receive signal path and the mixer circuitry 1322 of the transmit signal path may include two or more mixers and may be arranged for quadrature downconversion and upconversion, respectively. In some embodiments, the mixer circuitry 1322 of the receive signal path and the mixer circuitry 1322 of the transmit signal path may include two or more mixers and may be arranged for image rejection (e.g., Hartley image rejection). In some embodiments, the mixer circuitry 1322 of the receive signal path and the mixer circuitry 1322 may be arranged for direct downconversion and direct upconversion, respectively. In some embodiments, the mixer circuitry 1322 of the receive signal path and the mixer circuitry 1322 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1320 may include analog-to-digital converter (ADC) and digital-to-analog converter (DAC) circuitry and the baseband circuitry 1304 may include a digital baseband interface to communicate with the RF circuitry 1320.

In some dual-mode embodiments, a separate radio IC circuitry may be provided for processing signals for each spectrum, although the scope of the embodiments is not limited in this respect.

In some embodiments, the synthesizer circuitry 1328 may be a fractional—N synthesizer or a fractional N/N+1 synthesizer, although the scope of the embodiments is not limited in this respect as other types of frequency synthesizers may be suitable. For example, synthesizer circuitry 1328 may be a delta-sigma synthesizer, a frequency multiplier, or a synthesizer comprising a phase-locked loop with a frequency divider.

The synthesizer circuitry 1328 may be configured to synthesize an output frequency for use by the mixer circuitry 1322 of the RF circuitry 1320 based on a frequency input and a divider control input. In some embodiments, the synthesizer circuitry 1328 may be a fractional N/N+1 synthesizer.

In some embodiments, frequency input may be provided by a voltage controlled oscillator (VCO), although that is not a requirement. Divider control input may be provided by either the baseband circuitry 1304 or the application circuitry 1302 (such as an applications processor) depending on the desired output frequency. In some embodiments, a divider control input (e.g., N) may be determined from a look-up table based on a channel indicated by the application circuitry 1302.

Synthesizer circuitry 1328 of the RF circuitry 1320 may include a divider, a delay-locked loop (DLL), a multiplexer and a phase accumulator. In some embodiments, the divider may be a dual modules divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1328 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1320 may include an IQ/polar converter.

The FEM circuitry 1330 may include a receive signal path which may include circuitry configured to operate on RF signals received from one or more antennas 1332, amplify the received signals and provide the amplified versions of the received signals to the RF circuitry 1320 for further processing. The FEM circuitry 1330 may also include a transmit signal path which may include circuitry configured to amplify signals for transmission provided by the RF circuitry 1320 for transmission by one or more of the one or more antennas 1332. In various embodiments, the amplification through the transmit or receive signal paths may be done solely in the RF circuitry 1320, solely in the FEM circuitry 1330, or in both the RF circuitry 1320 and the FEM circuitry 1330.

In some embodiments, the FEM circuitry 1330 may include a TX/RX switch to switch between transmit mode and receive mode operation. The FEM circuitry 1330 may include a receive signal path and a transmit signal path. The receive signal path of the FEM circuitry 1330 may include an LNA to amplify received RF signals and provide the amplified received RF signals as an output (e.g., to the RF circuitry 1320). The transmit signal path of the FEM circuitry 1330 may include a power amplifier (PA) to amplify input RF signals (e.g., provided by the RF circuitry 1320), and one or more filters to generate RF signals for subsequent transmission (e.g., by one or more of the one or more antennas 1332).

In some embodiments, the PMC 1334 may manage power provided to the baseband circuitry 1304. In particular, the PMC 1334 may control power-source selection, voltage scaling, battery charging, or DC-to-DC conversion. The PMC 1334 may often be included when the device 1300 is capable of being powered by a battery, for example, when the device 1300 is included in a EGE. The PMC 1334 may increase the power conversion efficiency while providing desirable implementation size and heat dissipation characteristics.

FIG. 13 shows the PMC 1334 coupled only with the baseband circuitry 1304. However, in other embodiments, the PMC 1334 may be additionally or alternatively coupled with, and perform similar power management operations for, other components such as, but not limited to, the application circuitry 1302, the RF circuitry 1320, or the FEM circuitry 1330.

In some embodiments, the PMC 1334 may control, or otherwise be part of, various power saving mechanisms of the device 1300. For example, if the device 1300 is in an RRC Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1302 and processors of the baseband circuitry 1304 may be used to execute elements of one or more instances of a protocol stack. For example, processors of the baseband circuitry 1304, alone or in combination, may be used to execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

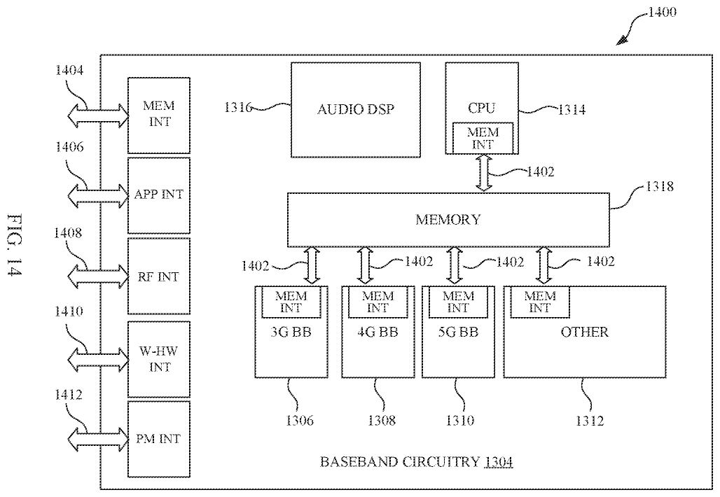

FIG. 14 illustrates example interfaces 1400 of baseband circuitry in accordance with some embodiments. As discussed above, the baseband circuitry 1304 of FIG. 13 may comprise 3G baseband processor 1306, 4G baseband processor 1308, 5G baseband processor 1310, other baseband processor(s) 1312, CPU 1314, and a memory 1318 utilized by said processors. As illustrated, each of the processors may include a respective memory interface 1402 to send/receive data to/from the memory 1318.

The baseband circuitry 1304 may further include one or more interfaces to communicatively couple to other circuitries/devices, such as a memory interface 1404 (e.g., an interface to send/receive data to/from memory external to the baseband circuitry 1304), an application circuitry interface 1406 (e.g., an interface to send/receive data to/from the application circuitry 1302 of FIG. 13), an RF circuitry interface 1408 (e.g., an interface to send/receive data to/from RF circuitry 1320 of FIG. 13), a wireless hardware connectivity interface 1410 (e.g., an interface to send/receive data to/from Near Field Communication (NFC) components, Bluetooth® components (e.g., Bluetooth® Low Energy), Wi-Fi® components, and other communication components), and a power management interface 1412 (e.g., an interface to send/receive power of control signals to/from the PMC 1334.

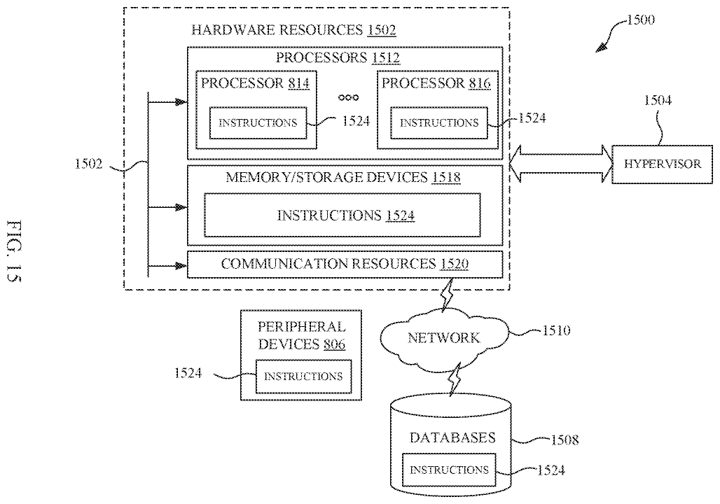

FIG. 15 is a block diagram illustrating components 1500, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1502 including one or more processors 1512 (or processor cores), one or more memory/storage devices 1518, and one or more communication resources 1520, each of which may be communicatively coupled via a bus 1522. For embodiments where node virtualization (e.g., NFV) is utilized, a hypervisor 1504 may be executed to provide an execution environment for one or more network slices/sub-slices to utilize the hardware resources 1502.

The processors 1512 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1514 and a processor 1516.

The memory/storage devices 1518 may include main memory, disk storage, or any suitable combination thereof. The memory/storage devices 1518 may include, but are not limited to any type of volatile or non-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1520 may include interconnection or network interface components or other suitable devices to communicate with one or more peripheral devices 1506 or one or more databases 1508 via a network 1510. For example, the communication resources 1520 may include wired communication components (e.g., for coupling via a Universal Serial Bus (USB)), cellular communication components, NFC components, Bluetooth & components (e.g., Bluetooth® & Low Energy), Wi-Fi® components, and other communication components.

Instructions 1524 may comprise software, a program, an application, an applet, an app, or other executable code for causing at least any of the processors 1512 to perform any one or more of the methodologies discussed herein. The instructions 1524 may reside, completely or partially, within at least one of the processors 1512 (e.g., within the processor's cache memory), the memory/storage devices 1518, or any suitable combination thereof. Furthermore, any portion of the instructions 1524 may be transferred to the hardware resources 1502 from any combination of the peripheral devices 1506 or the databases 1508. Accordingly, the memory of the processors 1512, the memory/storage devices 1518, the peripheral devices 1506, and the databases 1508 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

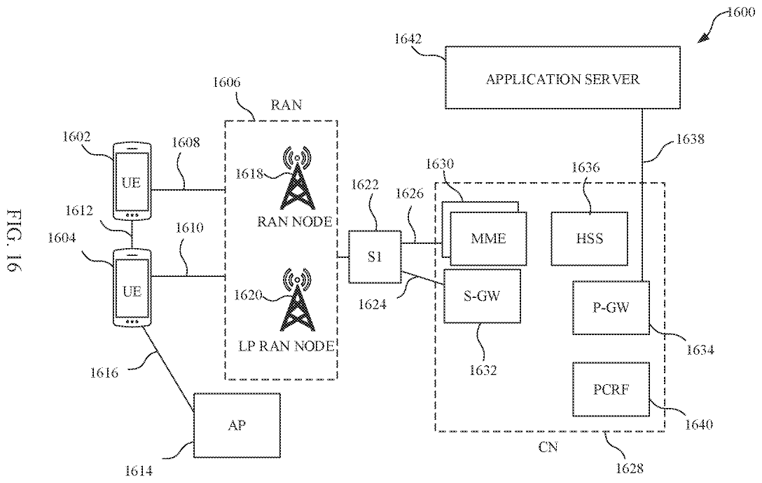

FIG. 16 illustrates an architecture of a system 1600 of a network in accordance with some embodiments. The system 1600 includes one or more user equipment (UE), shown in this example as a UE 1602 and a UE 1604. The UE 1602 and the UE 1604 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UE 1602 and the UE 1604 can comprise an Internet of Things (IOT) UE, which can comprise a network access layer designed for low-power IoT applications utilizing short-lived UE connections. An IOT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. The UE 1602 and the UE 1604 may be configured to connect, e.g., communicatively couple, with a radio access network (RAN), shown as RAN 1606. The RAN 1606 may be, for example, an Evolved ETniversal Mobile Telecommunications System (ETMTS) Terrestrial Radio Access Network (E-UTRAN), a NextGen RAN (NG RAN), or some other type of RAN. The UE 1602 and the UE 1604 utilize connection 1608 and connection 1610, respectively, each of which comprises a physical communications interface or layer (discussed in further detail below); in this example, the connection 1608 and the connection 1610 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1602 and the UE 1604 may further directly exchange communication data via a ProSe interface 1612. The ProSe interface 1612 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1604 is shown to be configured to access an access point (AP), shown as AP 1614, via connection 1616. The connection 1616 can comprise a local wireless connection, such as a connection consistent with any IEEE 802.11 protocol, wherein the AP 1614 would comprise a wireless fidelity (WiFi®) router. In this example, the AP 1614 may be connected to the Internet without connecting to the core network of the wireless system (described in further detail below).

The RAN 1606 can include one or more access nodes that enable the connection 1608 and the connection 1610. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1606 may include one or more RAN nodes for providing macrocells, e.g., macro RAN node 1618, and one or more RAN nodes for providing femtocells or picocells (e.g., cells having smaller coverage areas, smaller user capacity, or higher bandwidth compared to macrocells), e.g., a low power (LP) RAN node such as LP RAN node 1620. Any of the macro RAN node 1618 and the LP RAN node 1620 can terminate the air interface protocol and can be the first point of contact for the UE 1602 and the UE 1604. In some embodiments, any of the macro RAN node 1618 and the LP RAN node 1620 can fulfill various logical functions for the RAN 1606 including, but not limited to, radio network controller (RNC) functions such as radio bearer management, uplink and downlink dynamic radio resource management and data packet scheduling, and mobility management.

In accordance with some embodiments, the EGE 1602 and the EGE 1604 can be configured to communicate using Orthogonal Frequency-Division Multiplexing (OFDM) communication signals with each other or with any of the macro RAN node 1618 and the LP RAN node 1620 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-PDMA) communication technique (e.g., for uplink and ProSe or sidelink communications), although the scope of the embodiments is not limited in this respect. The OFDM signals can comprise a plurality of orthogonal sub carriers.

In some embodiments, a downlink resource grid can be used for downlink transmissions from any of the macro RAN node 1618 and the LP RAN node 1620 to the UE 1602 and the UE 1604, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1602 and the UE 1604. The physical downlink control channel (PDCCH) may carry information about the transport format and resource allocations related to the PDSCH channel, among other things. It may also inform the UE 1602 and the UE 1604 about the transport format, resource allocation, and H-ARQ (Hybrid Automatic Repeat Request) information related to the uplink shared channel. Typically, downlink scheduling (assigning control and shared channel resource blocks to the UE 1604 within a cell) may be performed at any of the macro RAN node 1618 and the LP RAN node 1620 based on channel quality information fed back from any of the UE 1602 and UE 1604. The downlink resource assignment information may be sent on the PDCCH used for (e.g., assigned to) each of the UE 1602 and the UE 1604.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to mine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1606 is communicatively coupled to a core network (CN), shown as CN 1628—via an SI interface 1622. In embodiments, the CN 1628 may be an evolved packet core (EPC) network, a NextGen Packet Core (NPC) network, or some other type of CN. In this embodiment the SI interface 1622 is split into two parts: the SI-U interface 1624, which carries traffic data between the macro RAN node 1618 and the LP RAN node 1620 and a serving gateway (S-GW), shown as S-GW 1632, and an S1-mobility management entity (MME) interface, shown as SI-MME interface 1626, which is a signaling interface between the macro RAN node 1618 and LP RAN node 1620 and the MME(s) 1630. In this embodiment, the CN 1628 comprises the MME(s) 1630, the S-GW 1632, a Packet Data Network (PDN) Gateway (P-GW) (shown as P-GW 1634), and a home subscriber server (HSS) (shown as HSS 1636). The MME(s) 1630 may be similar in function to the control plane of legacy Serving General Packet Radio Service (GPRS) Support Nodes (SGSN). The MME(s) 1630 may manage mobility aspects in access such as gateway selection and tracking area list management. The HSS 1636 may comprise a database for network users, including subscription-related information to support the network entities' handling of communication sessions. The CN 1628 may comprise one or several HSS 1636, depending on the number of mobile subscribers, on the capacity of the equipment, on the organization of the network, etc. For example, the HSS 1636 can provide support for routing/roaming, authentication, authorization, naming/addressing resolution, location dependencies, etc.

The S-GW 1632 may terminate the SI interface 322 towards the RAN 1606, and routes data packets between the RAN 1606 and the CN 1628. In addition, the S-GW 1632 may be a local mobility anchor point for inter-RAN node handovers and also may provide an anchor for inter-3 GPP mobility. Other responsibilities may include lawful intercept, charging, and some policy enforcement.

The P-GW 1634 may terminate an SGi interface toward a PDN. The P-GW 1634 may route data packets between the CN 1628 (e.g., an EPC network) and external networks such as a network including the application server 1642 (alternatively referred to as application function (AF)) via an Internet Protocol (IP) interface (shown as IP communications interface 1638). Generally, an application server 1642 may be an element offering applications that use IP bearer resources with the core network (e.g., ETMTS Packet Services (PS) domain, LTE PS data services, etc.). In this embodiment, the P-GW 1634 is shown to be communicatively coupled to an application server 1142 via an IP communications interface 1638. The application server 1642 can also be configured to support one or more communication services (e.g., Voice-over-Internet Protocol (VOIP) sessions, PTT sessions, group communication sessions, social networking services, etc.) for the UE 1602 and the UE 1604 via the CN 1628.

The P-GW 1634 may further be a node for policy enforcement and charging data collection. A Policy and Charging Enforcement Function (PCRF) (shown as PCRF 1640) is the policy and charging control element of the CN 1628. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1640 may be communicatively coupled to the application server 1642 via the P-GW 1634. The application server 1642 may signal the PCRF 1640 to indicate a new service flow and select the appropriate Quality of Service (QOS) and charging parameters. The PCRF 1640 may provision this rule into a Policy and Charging Enforcement Function (PCEF) (not shown) with the appropriate traffic flow template (TFT) and QoS class of identifier (QCI), which commences the QoS and charging as specified by the application server 1642.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a user equipment (UE), comprising: generating a message that includes an indication of a capability of the UE indicating whether the UE supports simultaneous measurement for at least two downlink (DL) beams; and transmitting the message to a base station.

Example 2 is the method of Example 1, wherein the indication includes a single bit indicating a general capability of the UE that the UE supports at least two simultaneous active DL beams.

Example 3 is the method of Example 1, wherein the indication includes a plurality of bits each of which indicates that the UE supports measurement for the DL beams for one of a plurality of functionalities.

Example 4 is the method of Example 3, wherein the plurality of functionalities comprises. Radio Resource Management (RRM), Radio Link Management (RLM), Beam failure detection (BFD), Candidate beam detection (CBD), L1-RSRP measurement, L1-SINR measurement, and data transmission.

Example 5 is the method of any one of Examples 1-4, wherein the indication includes a bit indicating a number of simultaneous active beams.

Example 6 is the method of any one of Examples 1-5, wherein the capability of the UE is indicated per band combination, per carrier or per UE.

Example 7 is the method of any one of Examples 1-6, wherein the DL beams are in mmWave.

Example 8 is the method of any one of Examples 1-7, wherein scaling factor of required time for a cell detection time, a measurement interval, or a cell evaluation time for cell reselection in idle/inactive mode is smaller than a legacy scaling factor for FR2.

Example 9 is the method of Example 8, wherein the scaling factors are 4, 3, 2, 2 for DRX cycle length 0.32 s, 0.64 s, 1.28 s, and 2.56 s, respectively.

Example 10 is the method of any one of Examples 1-9, wherein a time required to search a target cell when a handover command is received by the UE is shorter than a legacy time required to search a target cell for FR2.

Example 11 is the method of Example 10, wherein the time required to search a target cell is half of the legacy time required to search a target cell for FR2.

Example 12 is the method of any one of Examples 1-11, wherein a time period used in PSS/SSS detection is shorter than a legacy time period used in PSS/SSS detection for FR2.

Example 13 is a method for a base station (BS), comprising: receiving a message that includes an indication of a capability of a UE indicating whether the UE supports simultaneous measurement for at least two downlink (DL) beams from the UE.

Example 14 is the method of Example 13, wherein the indication includes a single bit indicating a general capability of the UE that the UE supports at least two simultaneous active DL beams.

Example 15 is the method of Example 13, wherein the indication includes a plurality of bits each of which indicates that the UE supports measurement for the DL beams for one of a plurality of functionalities.

Example 16 is the method of Example 15, wherein the plurality of functionalities comprises: Radio Resource Management (RRM), Radio Link Management (RLM), Beam failure detection (BFD), Candidate beam detection (CBD), L1-RSRP measurement, L1-SINR measurement, and data transmission.

Example 17 is the method of any one of Examples 13-16, wherein the indication includes a bit indicating a number of simultaneous active beams.

Example 18 is the method of any one of Examples 13-17, wherein the capability of the UE is indicated per band combination, per carrier or per UE.

Example 19 is the method of any one of Examples 13-18, wherein the DL beams are in mmWave.

Example 20 is a method for a base station (BS), comprising: generating a control signal that indicates whether data transmission or downlink (DL) beam measurement is prioritized for a user equipment (UE), and transmitting the control signal to the UE.

Example 21 is the method of Example 20, wherein the control signal includes a bit with a first value that indicates that at least one DL beams is fixed for data transmission.

Example 22 is the method of Example 20, wherein the control signal includes a bit with a second value that indicates that all of the DL beams are used for simultaneous measurement.

Example 23 is the method of any one of Examples 20-22, wherein the control signal is transmitted through at least one of: system broadcast information, dedicated Radio Resource Control (RRC) signaling, Media Access Control (MAC) command, or Downlink Control Information (DCI) command.

Example 24 is a method for a user equipment (UE), comprising: receiving a control signal from a base station (BS), wherein the control signal indicates whether data transmission or downlink (DL) beam measurement is prioritized for the UE.

Example 25 is the method of Example 24, wherein the control signal includes a bit with a first value that indicates that at least one DL beams is fixed for data transmission.

Example 26 is the method of Example 24, wherein the control signal includes a bit with a second value that indicates that all of the DL beams are used for simultaneous measurement.

Example 27 is the method of any one of Examples 24-26, wherein the control signal is received through at least one of: system broadcast information, dedicated Radio Resource Control (RRC) signaling; Media Access Control (MAC) command, or Downlink Control Information (DCI) command.

Example 28 is the method of Example 26, wherein scaling factor of required time for a cell detection time, a measurement interval, or a cell evaluation time for cell reselection in idle/inactive mode is smaller than a legacy scaling factor for FR2 in response to a determination that the control signal includes the bit with the second value.

Example 29 is the method of Example 28, wherein the scaling factors are 4, 3, 2, 2 for DRX cycle length 0.32 s, 0.64 s, 1.28 s, and 2.56 s, respectively.

Example 30 is the method of Example 26, wherein a time required to search a target cell when a handover command is received by the UE is shorter than a legacy time required to search a target cell for FR2 in response to a determination that the control signal includes the bit with the second value.

Example 31 is the method of Example 30, wherein the time required to search a target cell is half of the legacy time required to search a target cell for FR2.

Example 32 is the method of Example 26, wherein a time period used in PSS/SSS detection is shorter than a legacy time period used in PSS/SSS detection for FR2 in response to a determination that the control signal includes the bit with the second value.

Example 33 is an apparatus for a user equipment (UE), the apparatus comprising: one or more processors configured to perform steps of the method according to any of Examples 1-12 and 24-32.

Example 34 is an apparatus for a base station (BS), the apparatus comprising: one or more processors configured to perform steps of the method according to any of Examples 13-23.

Example 35 is a computer readable medium having computer programs stored thereon which, when executed by one or more processors, cause an apparatus to perform steps of the method according to any of Examples 1-32.

Example 36 is a computer program product comprising computer programs which, when executed by one or more processors, cause an apparatus to perform steps of the method according to any of Examples 1-32.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments. It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), comprising:
generating a message that includes an indication of a capability of the UE indicating whether the UE supports simultaneous measurement for at least two downlink (DL) beams; and
transmitting the message to a base station.

2. The method of claim 1, wherein the indication includes a single bit indicating a general capability of the UE that the UE supports at least two simultaneous active DL beams.

3. The method of claim 1, wherein the indication includes a plurality of bits each of which indicates that the UE supports measurement for the DL beams for one of a plurality of functionalities.

4. The method of claim 3, wherein the plurality of functionalities comprises:
Radio Resource Management (RRM),
Radio Link Management (RLM),
Beam failure detection (BFD),
Candidate beam detection (CBD),
L1-RSRP measurement,
L1-SINR measurement, and
data transmission.

5. The method of claim 1, wherein the indication includes a bit indicating a number of simultaneous active beams.

6. The method of claim 1, wherein the capability of the UE is indicated per band combination, per carrier or per UE.

7. The method of claim 1, wherein the DL beams are in mmWave.

8. The method of claim 1, wherein scaling factor of required time for a cell detection time, a measurement interval, or a cell evaluation time for cell reselection in idle/inactive mode is smaller than a legacy scaling factor for FR2.

9. The method of claim 8, wherein the scaling factors are 4, 3, 2, 2 for DRX cycle length 0.32 s, 0.64 s, 1.28 s, and 2.56 s, respectively.

10. The method of claim 1, wherein a time required to search a target cell when a handover command is received by the UE is shorter than a legacy time required to search a target cell for FR2.

11. The method of claim 10, wherein the time required to search a target cell is half of the legacy time required to search a target cell for FR2.

12. The method of claim 1, wherein a time period used in PSS/SSS detection is shorter than a legacy time period used in PSS/SSS detection for FR2.

13. A method for a base station (BS), comprising:
receiving a message that includes an indication of a capability of a UE indicating whether the UE supports simultaneous measurement for at least two downlink (DL) beams from the UE.

14. The method of claim 13, wherein the indication includes a single bit indicating a general capability of the UE that the UE supports at least two simultaneous active DL beams.

15. The method of claim 13, wherein the indication includes a plurality of bits each of which indicates that the UE supports measurement for the DL beams for one of a plurality of functionalities.

16. The method of claim 15, wherein the plurality of functionalities comprises:
Radio Resource Management (RRM),
Radio Link Management (RLM),
Beam failure detection (BFD),
Candidate beam detection (CBD),
L1-RSRP measurement,
L1-SINR measurement, and
data transmission.

17. The method of claim 13, wherein the indication includes a bit indicating a number of simultaneous active beams.

18. The method of claim 13, wherein the capability of the UE is indicated per band combination, per carrier or per UE.

19. (canceled)

20. A method for a base station (BS), comprising:
generating a control signal that indicates whether data transmission or downlink (DL) beam measurement is prioritized for a user equipment (UE); and
transmitting the control signal to the UE.

21. The method of claim 20, wherein the control signal includes a bit with a value that indicates that: at least one DL beams is fixed for data transmission; or all of the DL beams are used for simultaneous measurement.

22.-36. (canceled)
